(19) United States
(12) Patent Application Publication
(10) Pub. No.: US 2014/0215828 A1
(43) Pub. Date: Aug. 7, 2014

(54) VALVE MOUNTING FIXTURE FOR AN INTERNAL COMBUSTION ENGINE

(71) Applicant: ELECTRO-MOTIVE DIESEL, INC., LaGrange, IL (US)

(72) Inventors: Farhan Devani, Morton Grove, IL (US); Antone Long, LaGrange, IL (US)

(73) Assignee: ELECTRO-MOTIVE DIESEL, INC., LaGrange, IL (US)

(21) Appl. No.: 14/246,839

(22) Filed: Apr. 7, 2014

(51) Int. Cl. F02M 21/02; F02M 61/16

(52) U.S. Cl. CPC F02M 21/029; F02M 61/168
USPC 29/890.131; 248/205.1

(57) ABSTRACT

A valve mounting fixture is provided for an internal combustion engine. The fixture includes a first plate, a support member, a second support member and a second plate. The first plate has a plurality of through holes to detachably connect to an outside surface of an engine cylinder. The first support member is connected to the first plate and extends outwardly from the outside surface of the engine cylinder. The second support member has a first end connected to the first support member; the second support member has at least one adjustable connector. Further, a second plate is connected to a second end of the second support member, and the second plate has a plurality of mounting holes.

### TECHNICAL FIELD

The present disclosure relates generally to a fixture, and more particularly, to a valve mounting fixture for positioning a component such as a valve to inject gas into an engine cylinder.

### BACKGROUND

Currently, railroads may use diesel fuel engines to power their locomotive fleets. However, some railroads desire to convert or retrofit their older diesel fuel engines to natural gas engines for locomotive power. Converting an engine from diesel fuel to natural gas may require the installation of additional components, such as valves (i.e., Solenoid Operated Gas Admission Valves (SOGAVs)). Installation of such valves to inject fuel, such as natural gas into engine cylinders is needed for internal combustion. This installation may be difficult to achieve, as it may require the valves to be attached to the engine itself such as the engine crankcase, while packaged within a limited engine compartment space.

An example of a fixture that is located outside the engine compartment is disclosed in U.S. Patent Application Publication Number 2010/0251993 by Sugiyama, et. al. (“the '993 publication”). The fixture of '993 includes a gas fuel injection valve mounting bracket and gas fuel delivery pipe that supports a plurality of gas fuel injection valves for a dual-fuel internal combustion engine that are mounted on the cylinder head cover through a vibration absorbing member. Further, the at least one gas fuel injection valve is connected to an intake pipe through a gas fuel hose.

While this fixture may be capable of placing the gas fuel injection valve in the available space outside the engine at a lower side of the intake pipe, such that the total height to the internal combustion engine may be reduced and more compact, it may require an intake pipe located at the upper side of the engine for gas injection when maintenance is conducted. Thus, the injection of gas is accomplished distally, rather than in close proximity to the engine cylinder. Further, there is a lack of available space for mounting the gas injection valve at the lower side of the intake pipe, which further complicates matters when multiple valves may be installed.

The present disclosure is directed to overcoming one or more problems set forth above and/or problems of the prior art.

### SUMMARY OF THE DISCLOSURE

In one aspect of the present disclosure, a valve mounting fixture for positioning a component is disclosed. The fixture includes a first plate having a plurality of holes to detachably connect to an outside surface of engine cylinder and a first support member connected to the first plate and extending outwardly from the outside surface of the engine cylinder. The fixture also includes a second support member having a first end connected to the first support member, the second support member having at least one adjustable connector. Further, the fixture includes a second plate connected to a second end of the second support member, the second plate having a plurality of mounting holes.

In another aspect of the present disclosure, a method for mounting a valve is disclosed. The method includes mounting a first plate of a valve mounting fixture to an outside surface of an engine cylinder. The method also includes attaching a valve bracket to a second end of the valve mounting fixture; attaching the valve to a valve bracket; adjusting at least one of a plurality of adjustable connectors on the valve mounting fixture to achieve a desired valve position; securing the at least one adjustable connector corresponding to the desired valve position and welding the valve bracket to the engine crankcase. Further, the method provides for removing the valve mounting fixture.

Other features and aspects of this disclosure will be apparent from the following description and the accompanying drawings.

### BRIEF DESCRIPTION OF THE DRAWINGS

FIG. 1 is a perspective illustration of a valve mounting fixture that may be used for an internal combustion engine, according to one embodiment of the present disclosure;

FIG. 2 is a perspective illustration of an exemplary disclosed valve mounting fixture, as related to an engine cylinder and engine crankcase that may be used to position a valve to inject gas into the engine cylinder for an internal combustion engine;

FIG. 3 is a cross-sectional illustration of an exemplary disclosed valve mounting fixture, as related to an engine cylinder and an engine crankcase for an internal combustion engine; and

FIG. 4 is a block diagram of an exemplary disclosed method for a mounting valve, for an internal combustion engine.

### DETAILED DESCRIPTION

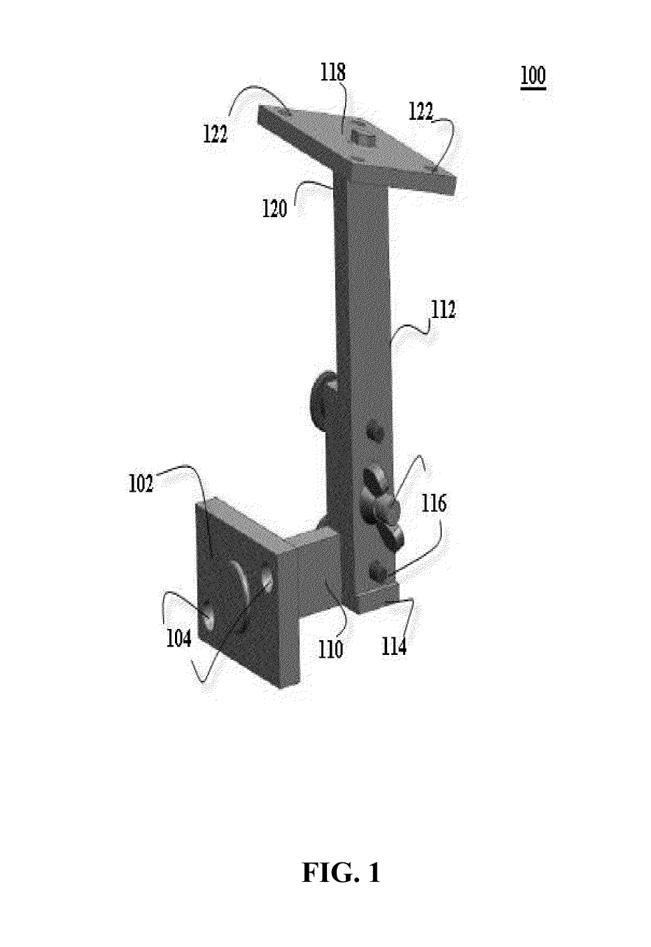

FIG. 1 is a perspective illustration of a valve mounting fixture 100 for an internal combustion engine, according to one embodiment of the present disclosure. For example, the engine may be a dual fuel internal combustion engine, such as a locomotive engine configured to operate using both diesel and natural gas. However, it should be understood that this may also include other fuel types, including compressed natural gas.

More particularly, FIG. 1 depicts the valve mounting fixture 100 that may be easily installed and detached within limited engine compartment space. For example, the valve mounting fixture 100 may include a first plate 102 having a plurality of through holes 104 to detachably connect to an outside surface 106 of an engine cylinder 108. As shown, the plurality of holes 104 used to mount the first plate 102 to the engine cylinder 108 may include at least two or more holes. In one embodiment, the first plate 102 may be mounted to the engine cylinder 108 with at least two bolts or similar mechanical fastening devices. Additionally, the at least one or more adjustable connectors 116 may be made of metallic material.

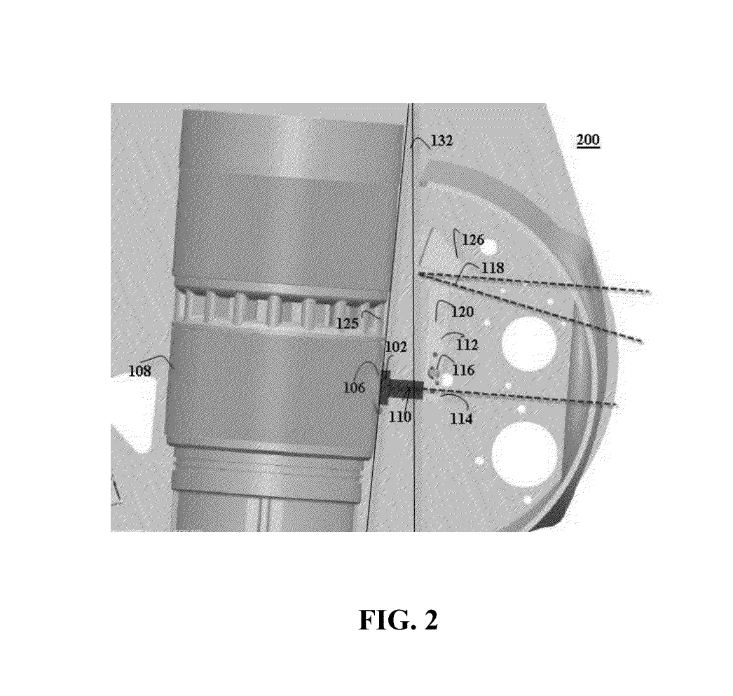

A first support member 110 may be perpendicularly connected to the first plate 102. This first support member 110 may be attached to the first plate 102 by welding or some similar means of attachment and extend outwardly from the outside surface 106 (FIG. 2) of the engine cylinder 108.

A second support member 112 having a first end 114 may be connected to the first support member 110. The second support member 112 may be attached to the first support member 110 by welding or some similar means. The second support member 112 may have at least one adjustable connector 116. In one embodiment, the second support member 112 may be “L” shaped. In an alternative embodiment the second support member 112 may be elongated in shape. At least one adjustable connector 116 may be capable of pivoting the second support member 112, while the first support member 110 may remain stationary. Similarly, at least one or more of the adjustable connectors 116 may be capable of positioning the second support member 112, while the first support member 110 may remain stationary. In one embodiment, the at least one or more adjustable connectors 116 may include pivot or quick release pins with winged nuts or some similar type of connector.

As shown, there may be a second plate 118 connected to a second end 120 of the second support member 112. The second plate 118 may be affixed to the second support member 112 by welding or some similar means. The second plate 118 may have a plurality of mounting holes 122. Some or all of the plurality of mounting holes 122 may be used to attach a valve bracket 128 to the second plate 118. In one embodiment, the second plate 118 may also have a pilot point or dowel that may be used for locating and consistently centering the valve bracket 126.

FIG. 2 illustrates an exemplary disclosed valve mounting fixture 200, as related to the engine cylinder 108 and the engine crankcase 132 that may be used to position a valve 124 at an optimal location to inject gas into the engine cylinder 108. For example, the valve mounting fixture 200 may be installed or detached in such a manner that the two components (i.e., the engine cylinder 108 and the engine crankcase 132, respectively) within the engine compartment space remain stationed in planes relative to one another. Moreover, the engine crankcase 132 may establish a vertical axis within the engine space compartment. The engine cylinder 108 may also follow the angle established by the crankcase. Thus, the outer surface 106 of the engine cylinder 108 may be positioned at an angle relative to the engine crankcase 132. For example, the valve mounting bracket 126 may be positioned at such an angle such that it may be attached to the engine crankcase 132 and used to position a valve 124 to inject gas into the engine cylinder 108 at an optimal location to inject gas into the engine cylinder 108. This optimal location may be achieved by positioning the valve 124 at an air intake port of the engine cylinder 108. This is a desired valve position 132 that allows gaseous fuel to be introduced with clean air that enters through the intake ports and may be ignited by liquid fuel that may be injected during each combustion cycle. The valve mounting bracket 126 may be attached to the engine crankcase 132 by welding or some similar means.

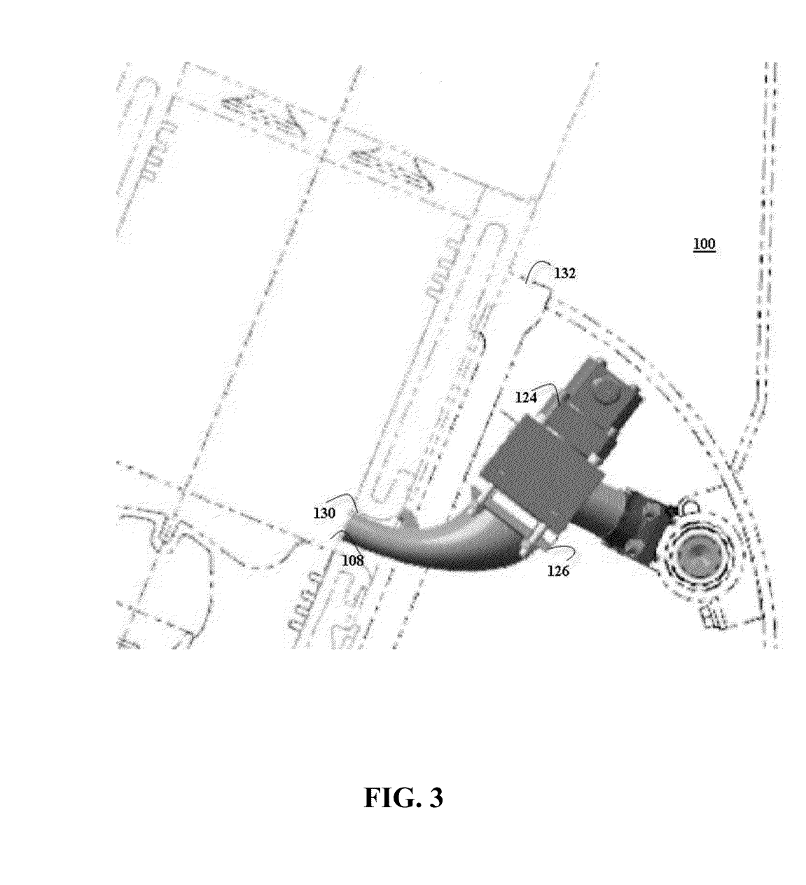

Referring to FIG. 3, the present disclosure shows a cross-sectional illustration of an exemplary disclosed valve mounting fixture 300, relative to the engine cylinder 108 and the engine crankcase 132. More particularly, these two components remain fixed in planes relative to one another, whether the valve mounting fixture 300 is in the installed and/or detached position within the engine compartment. As shown, the valve mounting fixture 300 may reference the engine cylinder 108 in order to position a valve 124 at an optimal location to inject gas into the engine cylinder 108. The valve 124 may also be optimally positioned at the air intake port of the engine cylinder 108. Further, the valve mounting fixture 300 may reference the engine crankcase 132. The valve mounting bracket 126 may be attached to the engine crankcase 132. The valve mounting bracket 126 may be attached to the engine crankcase 132 by welding or some similar means.

### INDUSTRIAL APPLICABILITY

Currently, the majority of railroads use diesel fuel engines to power their locomotive fleets. However, due to the high costs associated with diesel fuel and stringent emission regulations, some railroads are beginning to convert or retrofit their older locomotive fleets from the use of diesel fuel to natural gas or dual fuel engines. Converting an engine from diesel fuel to natural gas may require the installation of additional components, such as valves (i.e., Solenoid Operated Gas Admission Valves (SOGAVs)). Installation of such valves to inject fuel such as natural gas into engine cylinders is needed for internal combustion. This installation may be difficult to achieve, as it may require the valves to be attached inside the engine itself, such as the engine crankcase, while packaged within a limited space within the engine compartment.

In the present disclosure, the valve mounting fixture 200, as related to the engine cylinder 108 and the engine crankcase 132, may be used to position a valve 124 at an optimal location to inject gas into the engine cylinder 108. For example, the valve mounting fixture 200 may be referenced off of two components within the engine compartment space that are located in planes perpendicular to one another (i.e., the engine cylinder 108 and the engine crankcase 132) for ease of mounting of valve 124.

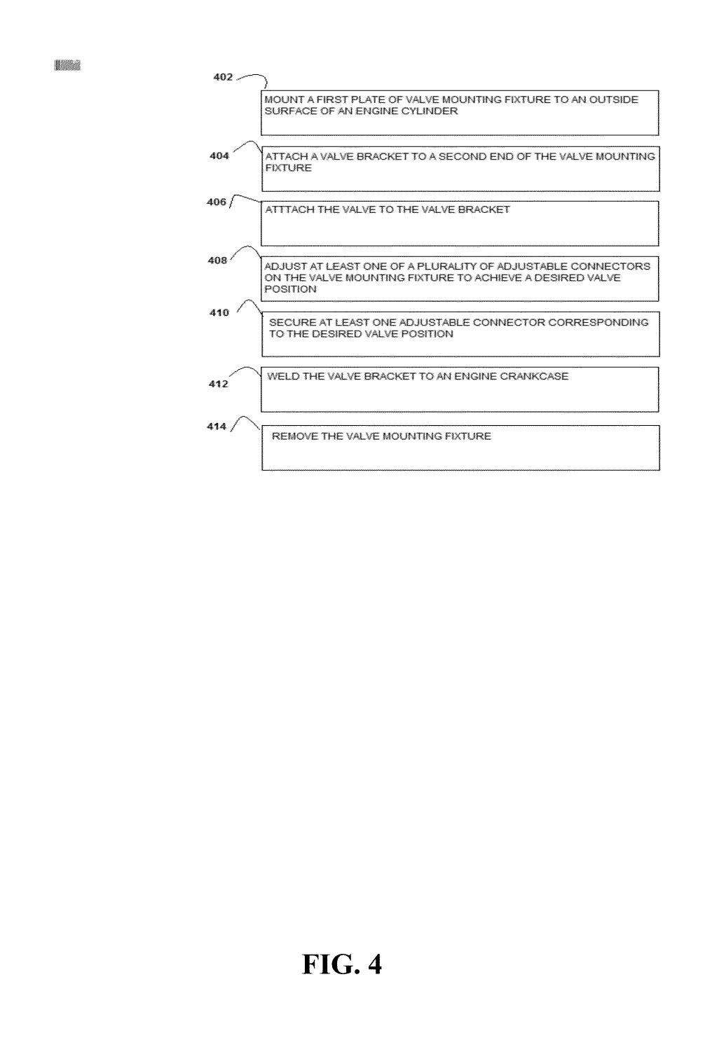

A method for mounting a valve 400 within an internal combustion engine is described in connection with FIG. 4.

At a first step 402, a valve mounting fixture 100 is mounted to a first plate 102 on an outside surface 126 of an engine cylinder 122. At a second step 404, a valve bracket 128 is attached to a second end 116 of the valve mounting fixture 100. At a third step 406, the valve 124 is attached to the valve bracket 128. At a fourth step 408, at least one of a plurality of adjustable connectors 112 is adjusted on the valve mounting fixture 100 to achieve a desired valve position 130. At a fifth step 410, at least one adjustable connector 116 is secured corresponding to the desired valve position 130. At a sixth step 412, the valve bracket 126 is welded to an engine crankcase 132. At a seventh step 414, the valve mounting fixture 100 is removed.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A valve mounting fixture, comprising:
a first plate having a plurality of through holes to detachably connect to an outside surface of an engine cylinder;
a first support member connected to the first plate and extending outwardly from the outside surface of the engine cylinder;
a second support member having a first end connected to the first support member, the second support member having at least one adjustable connector; and
a second plate connected to a second end of the second support member, the second plate having a plurality of mounting holes.

2. The fixture of claim 1, wherein the fixture is configured to position a valve at an optimal location to inject gas into the engine cylinder.

3. A method of mounting a valve, comprising:
mounting a first plate of a valve mounting fixture to an outside surface of an engine cylinder;
attaching a valve bracket to a second end of the valve mounting fixture;
attaching the valve to the valve bracket;
adjusting at least one of a plurality of adjustable connectors on the valve mounting fixture to achieve a desired valve position;
securing the at least one adjustable connector corresponding to the desired valve position;
welding the valve bracket to an engine crankcase; and
removing the valve mounting fixture.
